(19) United States
(12) Patent Application Publication
(10) Pub. No.: US 2005/0228741 A1
(43) Pub. Date: Oct. 13, 2005

(54) Financial instrument trading system and method

(75) Inventor: Steve Leibowitz, Las Vegas, NV (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Hotspot FX, Inc.

(21) Appl. No.: 11/005,311

(22) Filed: Dec. 6, 2004

Related U.S. Application Data
(63) Continuation-in-part of application No. 10/821,118, filed on Apr. 8, 2004.

(51) Int. Cl. G06F 17/60

(52) U.S. Cl. 705/37

(57) ABSTRACT

A computerized trading system for facilitating transactions of financial instruments between a plurality of traders. The computerized trading system includes a user interface, a matching engine, and a trade restrictor. The trade restrictor may be configured to detect bids and offers deviating from an expected price range, from an expected time delay or having exceeded a certain volume, and to restrict booking of the bids and offers meeting these criteria. For example, bids and offers resulting a an inverted market may be cancelled or adjusted. The inverted market occurs when a new or existing bid is higher than a best offer, or a new or existing offer is lower than a best bid. The price range criteria can also be set using statistical ranges calculated based on current bids and offers, or bids and offers that have been supplied by the same trader of the bids and offers being restricted.

### CROSS-REFERENCES TO RELATED APPLICATIONS

This application is a continuation-in-part of copending U.S. Patent Application Serial No. application Ser. No. 10/821,118, filed on Apr. 8, 2004, which is hereby incorporated herein in its entirety by reference.

### BACKGROUND OF THE INVENTION

1. Field of the Invention

The present invention is related to systems, methods and computer program products to match trades for financial transactions between buyers and sellers, and more particularly to systems, methods and computer program products that can selectively restrict trades between traders.

2. Description of Related Art

Foreign exchange trading often involves the use of substantial credit or margin to allow the purchase of large amounts of currency. Existing computer systems for matching foreign exchange bids and offers often confirm that sufficient credit is available between parties prior to matching a bid and an offer. If sufficient credit is not available between the parties, the trade is blocked.

For example, U.S. Pat. No. 5,375,055 to Togher et al. (“Togher”) discloses an electronic trading system interconnecting a plurality of trader workstations WS for facilitating the buying and selling of large blocks of foreign currency, as shown in FIG. 1 of Togher. Subgroups of the plurality of trader workstations are attached to market access nodes MAN which are under the control of an administrator (e.g., a bank) and maintains transaction records, credit limits and other confidential information, as described at column 5, lines 10-15 of Togher. Arbitrator nodes ARB identify matches between buyers and sellers, as described at column 5, lines 25-30 of Togher.

Each of the market access nodes contains detailed credit information on potential traders. The credit information indicates the amount of credit a particular market access node is willing to extend to each possible counterparty trader, as described at column 2, lines 48-57 of Togher. These credit limits are used to create preauthorization matrices which indicate simple yes or no answers as to whether credit is available between potential counterparties, as shown in FIG. 6 of Togher. In one aspect, Togher discloses that the arbitrator node can display an offer or bid as dealable to the workstation, but allow the respective market access node to block the above limit portion of the trade. In another aspect, the entire trade may be blocked, as described at column 3, lines 1-10 of Togher. Ostensibly, maintaining the more detailed credit information only on at the market access node preserves the anonymity of the traders.

U.S. Patent Application Publication No. 2003/0088499 to Gilbert et al. (“Gilbert”) discloses an electronic trading system 101 having local workstations 102 and remote workstations 104 connected via networks 108 and 110 to a processor 106, as shown in FIG. 1 of Gilbert. Bids and offers submitted by the workstations are communicated over the networks to the processor to be ranked and stored in a bid and offer queue, as described in paragraph 25 of Gilbert. These bids and offers are sent to a display 200 that is associated with an interface 300 which is presented on a trader's workstation for hitting or lifting.

Traders acting at one of the workstations as a broker trader, on behalf of a principal trader, are subject to a special designation and limitations by the trading system. For example, a trader acting for a principal may be permitted to hit bids of broker traders only when those broker traders are representing certain principals, as described in paragraph 32 of Gilbert. FIG. 5 of Gilbert illustrates a process 500 for the setting switches by the principal to selectively limit trades with various counterparties. The process displays bids and offers with color coding, or other indications, that a bid or offer is or is not available based on those switches, as described at paragraph 44 of Gilbert.

Despite the ability of the financial trading system of Togher to block trades based on credit information and the financial trading system of Gilbert to block trades based on a counterparty's identity, further centralized controls over trading are needed, especially on systems for facilitating the exchange of foreign currencies. At the same time, due to the generally decentralized market for foreign currencies when compared with securities such as stocks and bonds, any limitations to the trading of currencies by a foreign currency exchange trading system need to be carefully balanced so as to not interfere an undue amount with the liquidity and depth of the market hosted by the system.

Therefore, it would be advantageous to have a system for facilitating the exchange of financial instruments that can exercise further controls over the trading of financial instruments, especially the trading of foreign currencies. In addition, it would be advantageous if the controls optimized and enhanced the liquidity of the market hosted by the system, especially the liquidity of a foreign currency exchange market.

### BRIEF SUMMARY OF THE INVENTION

The present invention addresses the above needs and achieves other advantages by providing a computerized trading system for facilitating transactions of financial instruments between a plurality of traders. Generally, the computerized trading system includes a user interface, a matching engine, and a trade restrictor. The trade restrictor may be configured to detect bids and offers deviating from an expected price range, from an expected time delay or having exceeded a certain volume, and to restrict booking of the bids and offers meeting these criteria. As an example of the price range criteria, bids and offers resulting a an inverted market may be cancelled or adjusted. The inverted market occurs when a new or existing bid is higher than a best offer, or a new or existing offer is lower than a best bid. The price range criteria can also be set using statistical ranges calculated based on current bids and offers, or previous bids and offers that have been supplied by the same trader of the bids and offers being restricted.

In one embodiment, the present invention includes a computerized trading system for facilitating transaction of financial instruments between a plurality of traders. Included in the trading system is a user interface that is configured to receive a plurality of bids and offers from the traders and store the bids and offers in a memory. Each of the bids and offers has transaction information associated with it, including at least a price, a quantity and a type of financial instrument. A matching engine is configured to compare the bids and offers and to match the bids and offers using the transaction information. A trade restrictor of the trading system is configured to receive the bids and offers from the memory, detect which of the bids and offers has a price that deviates from the expected price range and restrict booking of the bids and offers with deviating prices.

The expected price range can be defined in different ways. For example, the expected price range could be defined by inverted market criteria that requires bids to be equal to or lower than a best offer, or offers to be equal to or higher than a best bid. The expected price range could also exclude bids or offers that are equal to current best offers or bids, respectively. Bids and offers deviating from the inverted market criteria can be cancelled, replaced with bids and offers meeting the inverted market criteria or presented to their respective traders for approval before posting and matching.

As another example, the expected price range can be defined statistically. Standard deviations, or other statistical formulae, can be used to process existing bids and offers to define the expected price range. Also, statistical formulae can be used to determine characteristics of a particular trader's previous behavior which are set as the expected price range.

In another embodiment, the trade restrictor is configured to calculate a delay associated with each of the bids and offers, detect whether the delay deviates from a delay range and restrict booking of each of the bids and offers having the delay deviating from the delay range. For example, each of the bids and offers may include a timestamp which is used to calculate a delay from the time at which the bids and the offers were recorded. This allows restriction of “stale” bids and offers, thereby protecting the trader from filing of a potentially off market bid or offer. In addition, or alternatively, the delay can be calculated from the time of the match by using a match timestamp issued by the matching engine wherein the bids and offers are each associated with a trader. In this example, the trade restrictor is configured to calculate the delay between matches made for trades between the same pair of traders. This prevents any particular trader from alternatively buying and selling similar financial instruments from the same opposing trader, such as a market maker, and driving up transaction costs for the market maker with no net result.

In another embodiment, the trading system can include a skew generator that generates the price associated with the bids or offers of a selected trader. For example, the skew generator can take a base price and increase it or decrease it by one or more pips for more or less aggressive bids or offers. The trade restrictor in this instance is configured to calculate a total volume of bids or offers matched by the matching engine and having a same trader identification, detect whether the total volume exceeds a volume range and reduce the skew amount used by the skew generator in response to the total volume exceeding the volume range. The skew amount may even be reduced to zero, in essence shutting off or eliminating the skew.

The present invention includes many advantages. For example, the various off market filters that can be implemented by the trade restrictor serve to control situations in which stale, incorrect, inefficient or predatory bids and offers are being submitted, thus protecting the traders, and in particular, the market making banks that provide a depth of market with automated bids and offers. For example, controlling deviations from an expected price range using an inverted market filter, a choice market filter and an expected range filter protects a trader from posting bids and offers that may subject them to large losses. Bids and offers that have excessively high or low prices as determined by different metrics are adjusted to reflect prevailing market conditions, sent to the trader for approval or simply removed or not presented for a transaction. Similarly, the use of a delay range to by a time interval filter inhibits placement or matching of stale bids and offers, or closely timed bids and offers between a same pair of traders. This prevents any particular trader from alternatively buying and selling similar financial instruments from the same opposing trader, such as a market maker, and driving up transaction costs for the market maker with no net result. The present invention can also detect deviations from expected volumes, which can be used to reduce or eliminate skew amounts applied to automated bids and offers.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic of a computerized trading system of one embodiment of the present invention;

FIG. 2 is a collection of GUIs, including trade entry, open positions, deal log and credit GUIs, generated by the computerized trading system of FIG. 1;

FIG. 3 is a bid box generated by the computerized trading system of FIG. 1;

FIG. 4 is an offer box generated by the computerized trading system of FIG. 1;

FIG. 5 is a lift window generated by the computerized trading system of FIG. 1;

FIG. 6 is a trade confirmation window generated by the computerized trading system of FIG. 1;

FIG. 7 is an average log screen generated by the computerized trading system of FIG. 1 and displaying an all deals tab;

FIG. 8 is the average log screen of FIG. 7 displaying an averaging tab;

FIG. 9 is the average log screen of FIG. 7 displaying a final tab;

FIG. 10 is a re-price balance window generated by the computerized trading system of FIG. 1;

FIG. 11 is a single layer feed message generated by the computerized trading system of FIG. 1;

FIG. 12 is a multi-layer feed message generated by the computerized trading system of FIG. 1;

FIG. 13 is a flow diagram of operation of a trading platform according to another embodiment of the present invention;

FIG. 14 is a schematic of a trading platform according to another embodiment of the present invention;

FIG. 15 is a flow diagram of operation of an inverted market filtering module according to another embodiment of the present invention;

FIG. 16 is a flow diagram of operation of a choice market filtering module according to another embodiment of the present invention;

FIG. 17 is a flow diagram of operation of an expected range filtering module according to another embodiment of the present invention;

FIG. 18 is a flow diagram of operation of an intentional skew filtering module according to another embodiment of the present invention; and

FIG. 19 is a flow diagram of operation of time interval filtering module according to another embodiment of the present invention.

### DETAILED DESCRIPTION OF THE INVENTION

The present inventions now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

System Overview

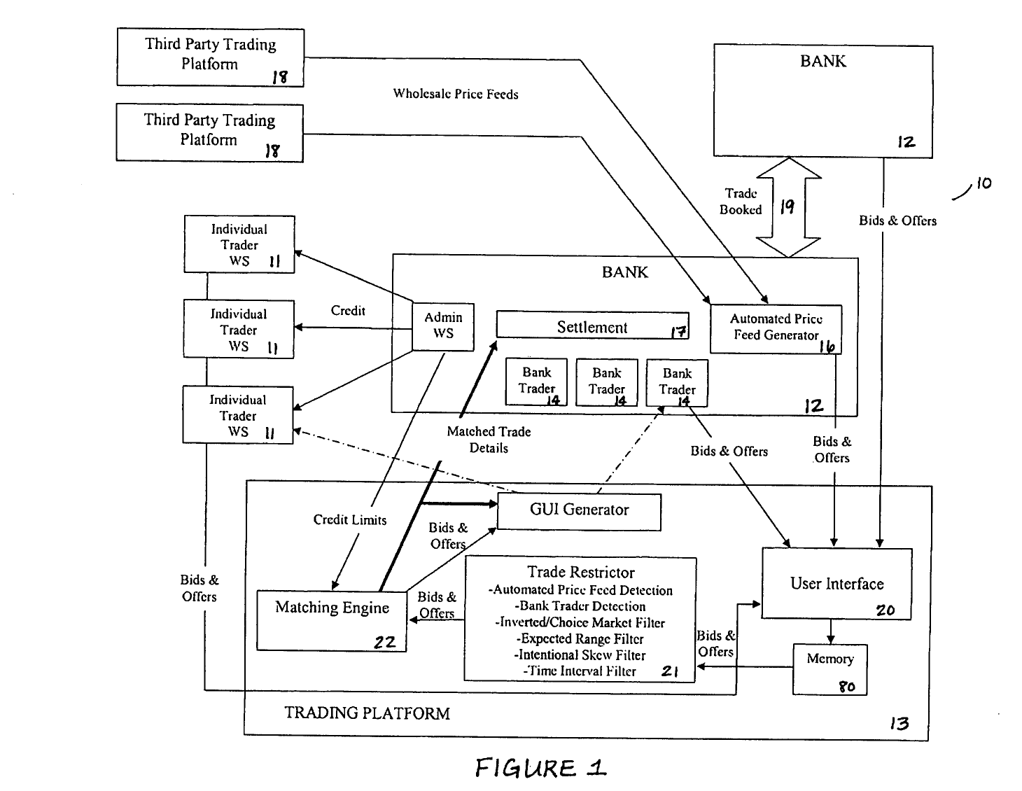

A computerized trading system 10 of one embodiment of the present invention is shown in FIG. 1. The computerized trading system includes a plurality of individual trader workstations (WS) 11 and a plurality of bank computer systems 12 electronically connected to a computerized trading platform 13. Generally, groups of the trader workstations 11 are associated with a respective one of the bank computer systems 12 which extend credit to the traders of each of their workstations allowing them to submit bids and offers for financial instruments on the trading platform 13. The trading platform provides the trader workstations 11 and the bank computer systems 12 with information on the bids and offers of other trader workstations and bank computer systems and matches bids with offers so as to facilitate closing of matched bids and offers for the financial instruments.

The term “bank” as used herein denotes generally any institution, individual, firm or other entity that has sufficient resources to extend credit to traders for use in trading financial instruments. For instance, the bank can be a brokerage, a lending institution, or a trusted individual with known financial resources. The term “financial instruments” as used herein denotes any type of property, such as stock, bonds, futures, derivatives, foreign exchange contracts, commodities, golf memberships, collectibles, etc., or any other property interest, real, intangible or otherwise, that can be exchanged for consideration. It should be also noted that the term “network” as used herein should be construed broadly to include all types of electronically assisted communication such as wireless networks, local area networks, wide area networks, public networks such as the Internet, public telephone networks, or various combinations of different networks.

Bank Computer System

Referring again to the embodiment of FIG. 1, each of the bank computer systems 12 has a collection of computers interconnected via a network, such as a local area network, including a plurality of bank trader workstations 14, one (or more) administrative workstations 15, an automated price feed generator 16 and a settlement system 17. Generally, each bank computer system and the component computer systems thereof are connected in electronic communication over one or more networks (represented by the lines indicating exemplary flows of data) to the other computer systems of the computerized trading system 10. In one aspect, communication may be facilitated by the computerized trading platform 13 providing an application programming interface (API). The API includes a template defining the format of communication messages and a library of functions that are made accessible to the other computer systems.

Workstations

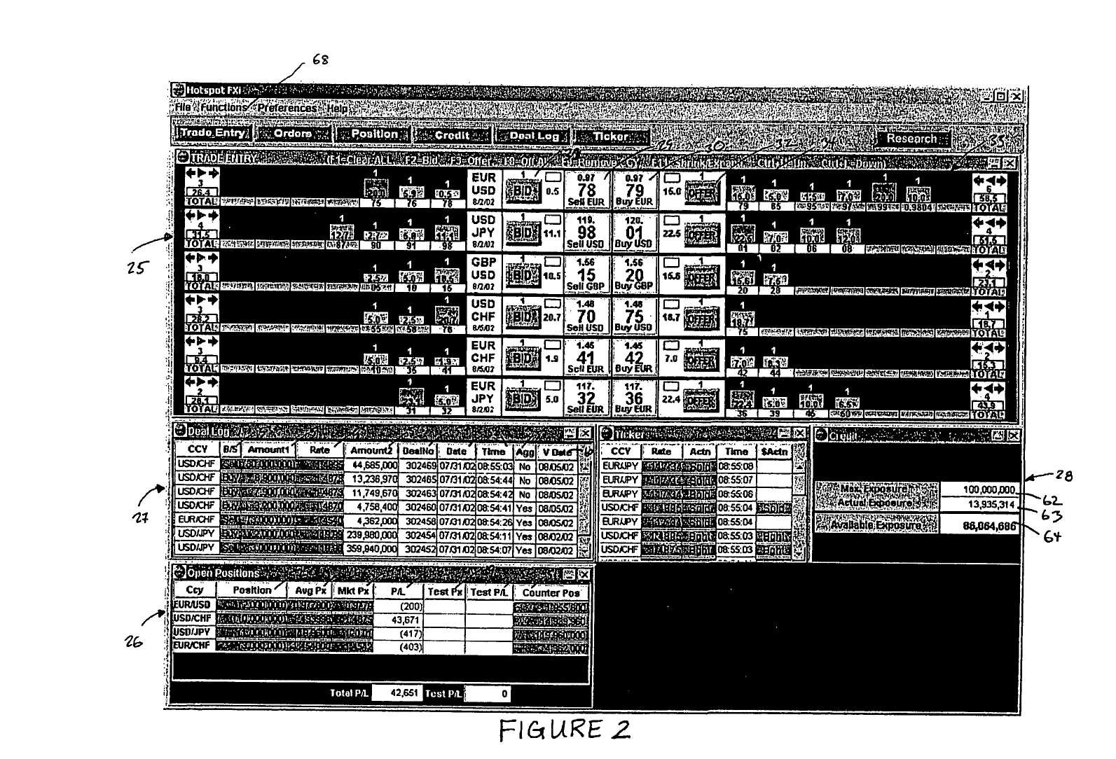

Preferably, the bank trader workstations 14 are computers that are connected in communication (e.g., connected in electronic communication, such as a via a network) with the trading platform 13 and are capable of displaying a plurality of graphical user interfaces (GUI) that allow the bank traders to interact and exchange information with the trading platform. These GUIs, for instance, allow the bank traders to submit bids and offers, and to receive and display the bids and offers of other traders, information on completed trades, open positions and credit exposures. The various GUIs for interacting with the trading platform will be described in more detail below in relation to FIGS. 2-10.

The administrative workstations 15 are also computers connected in communication with the trading platform 13 and are configured to manage credit limits and enablement of the traders associated with its bank and that bank's individual trader clients. For instance, the administrative workstation 15 can record and send information, using various GUIs, describing credit limits for each of its individual trader workstations 11 and bank trader workstations 14 to the trading platform 13, as indicated by the solid line of FIG. 1. In addition to changing the credit limits of its own trader workstations, the administrative workstations 15 can send information to the trading platform 13 for setting and changing the credit limits extended to other banks and traders. Typically, in the system of the present invention, credit limits are not set for the traders of other banks, only the other banks, so that the anonymity of the traders can be preserved.

In addition, the administrative workstations 15 are configured to control access to the trading platform 13 by the workstations 11, 14. For instance, the administrative workstations 15 can disable an individual workstation 11 so that the individual trader can view trade information, but cannot trade using the trading platform 13, or can neither view information, nor trade using the trading platform. Credit and enablement information are preferably stored on servers or other computers of the trading platform for use thereby in controlling access to the platform and the matching of bids and offers.

Automated Price Feed Generator

In the embodiment illustrated in FIG. 1, the automated price feed generator 16 is a computer system connected in communication with one or more third party trading platforms 18, from which can be obtained continuous wholesale pricing data on one or more financial instruments. The automated price feed generator 16 is configured to apply various formulae developed by the bank to the wholesale price feed to generate an automated price feed of bids and offers for use on the trading platform 13. Typically, the automated price feed generator takes the bids and offers from other markets and adds some type of a spread that allows offsetting transactions to be made by the bank in the two markets to capture the value of the spread. The automated price feed generator 16 is also connected in communication with the trading platform 13, such as via a network, allowing the transmission of the automated bids and offers to the trading platform, as shown by FIG. 1.

Alternatively, the automated price feed generator 16 can be configured to automatically generate bids and offers without the use of wholesale price feed data from third party platforms. For instance, the market making bank can use internal data, or various analytical processes, to generate a price feed without other price feed inputs. Also, the price feed could be generated by outside inputs other than wholesale price feeds, such as by using information on world events, interest rates, etc. Regardless, the term “automated” or “automated price feed” as used herein refers to any at least partially machine-generated series of bids and/or offers.

Advantageously, these automated price feeds provide additional depth of market for the individual trader workstations 11 and revenue for the banks who are acting as market makers. However, dealing by one bank on the automated price feeds of another bank can cause problems. The automated price feeds hosted by the bank are motivated in part by wanting to provide liquidity to the market. However, the price feeds of one bank can lag another bank, resulting in matching of the bank's price feeds and reducing the liquidity of the market. Also, dealing on the price feeds by bank trader workstations 14 may cause problems due to the competitive nature of the relationship between the banks. The computerized trading system 10 of the present invention has, in part, been developed to avoid this situation by selectively restricting market maker-to-market maker trading and/or trading on automated price feeds between market makers, i.e., to restrict trading based also on participant type or identity. This provides liquidity to the traders, but avoids giving market makers access to the liquidity of other market makers. Notably, not all banks will include the automated price feed generator 16, as some banks will not act as market makers, or will manually supply bids and offers as a market maker. Therefore, the present system may also restrict transactions between market makers on non-automated bids and offers.

Settlement System

The settlement system 17 is connected in communication with the trading platform 13 and receives details on matched trades therefrom. This information is used by the settlement system 17 for clearing purposes, wherein the trades are actually completed at the prices, quantities, and other terms of the matched bids and offers, as is indicated by the arrow 19 marked “trade booked” between the bank computer systems 12, as shown in FIG. 1. Matched trade details can also be sent by the settlement system 17 to the various trader workstations 11, 14 for display thereon, or the matched trade details can be received directly from the trading platform 13, or via other, less direct sources. It should be noted that although booking of trades is implemented in the above-described embodiment, trades could be booked directly between individuals, with clearinghouses, etc., and still be within the scope of the present invention.

Notably, the settlement system may involve the use of non-electronic, non-computer systems to complete the final transfer of ownership to the financial instruments and consideration therefore. Similarly, each of the systems described herein, in various embodiments, may include a collection of manual and automated processes and components. To this end, the term “computerized” as used herein denotes the use of various electronic and automated processes, but not necessarily an entirely electronic and automated process.

Trading Platform

As shown in FIG. 1, the trading platform 13 of the computerized trading system 10 includes a bid and offer recording system 20, a memory 80 for storing the bids and offers, a trade restricting system 21, a matching engine 22 and a GUI generator 23. The bid and offer recording system 20 is configured to receive the bid and offer information submitted by the individual trader workstations 11, the bank trader workstations 14 and the automated price feed generator 16. The bid and offer recording system 20 is also configured to communicate the bid and offer information to the trade restricting system 21.

Bid and Offer Recording System

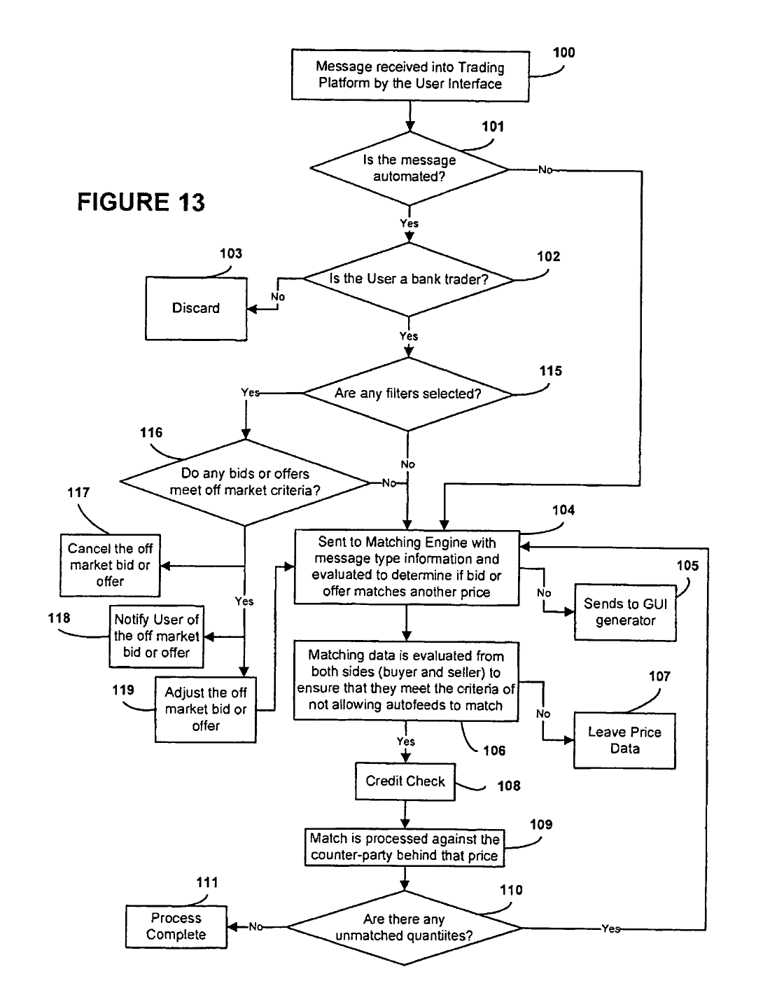

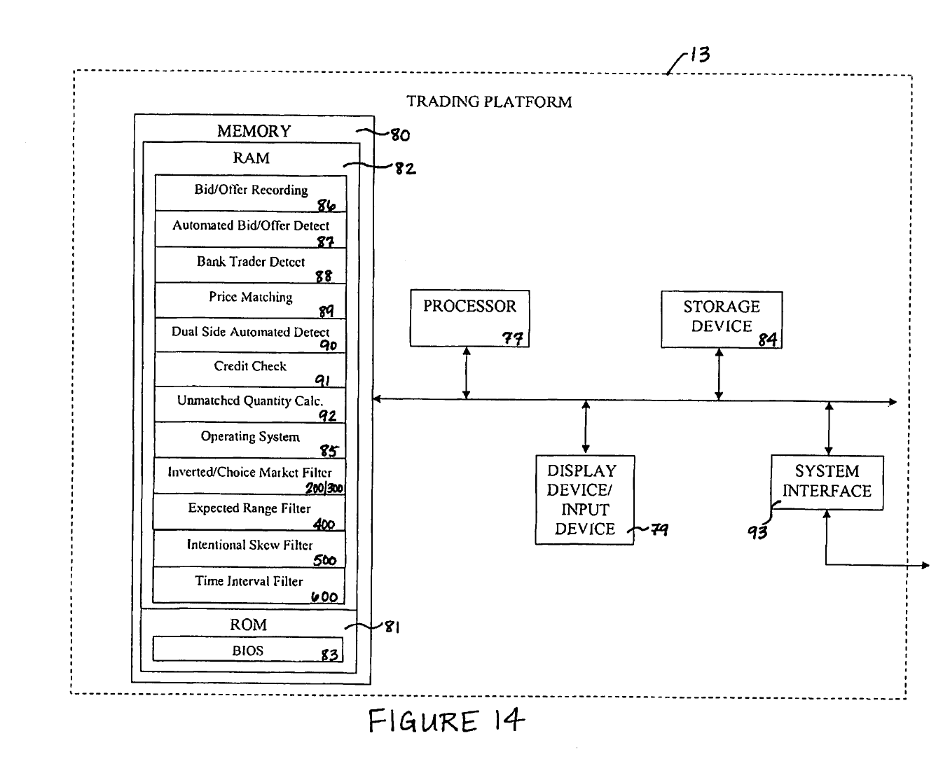

Preferably, the bid and offer recording system 20 works in coordination with a plurality of GUIs generated by the GUI generator 23 and used to prompt and record various bids and offers from the individual and bank traders, as shown by block 100 of the flow chart of FIG. 13. It should be noted that GUIs are not necessarily involved in submitting the automated bids and offers to the bid and offer recording system 20, although GUIs are often employed to monitor and generate such automated bids and offers. Further, the GUIs may be generated and associated with the bank computer systems 12, or the workstations 11, 14, and therefore the bid and offer recording system 20 and the trading platform 13 only see bid and offer messages, and not any GUIs associated therewith. Regardless of how they are generated, the bids and offers are preferably electronic messages in a standardized format once they reach the recording system 20, or the recording system is configured to convert them to a standardized format for communication to the other platform systems, such as the formats illustrated in FIGS. 11 and 12.

Message Format

The single-layer feed message format illustrated in FIG. 11 includes an alphanumeric string which has several fields separated by pipes “|”. These fields include, in order, a message type field (1), an account field (2), a user identification field (3), an instrument identification field (4), a bid cancellation field (5), an offer cancellation field (6), a new bid request field (7), a new bid price field (7a), a new bid quantity field (7b), a new bid show quantity field (7c), new bid filtering instructions (7d-h), a new offer request field (8), a new offer price field (8a), a new offer quantity field (8b), a new offer show quantity field (8c), and new offer filtering instructions (8d-h).

The single-layer feed message is designed so that automatically generated price feeds do not build up over time and stay at a single layer. The single-layer feed message format is configured to do this by providing for cancellation of previous bids and offers via the bid cancellation field (5) and the offer cancellation field (6). If the cancellation fields (5) and (6) are zero, then no cancellation is made. If other than zero, then additional price (a), quantity (b) and show quantity (c) fields are generated to facilitate identification of the bid or offer to be cancelled. The other fields, as is evident from their names, identify the type of message as a bid or offer generated by automation (220 or 230), the account on which the deal is made, the trader making the trade, the financial instrument (e.g., the currency pair), and the price, quantity and reserve quantity for the new bid or offer.

Multi-layer feed messages, on the other hand, allow for submission of multiple bids and offers and do not provide for cancellation of previous offers, as shown in FIG. 12. As a result, previous bids and offers remain on the trading platform 13 for matching by the matching engine 22. Fields (1) through (4) are the same for the multi-layer feed as the single-layer feed. The multi-layer feed message format includes a number of requests field (5) that identifies the number of bids or offers to follow, which, in the illustrated example, is equal to two. As is indicated by the number of requests field (5) two groups of fields each include a buy/sell identification field (a), a request identification field (b), a price field (c), a quantity field (d), a show quantity field (e), a skew amount field (f), and filtering instruction fields (g-k). The number of requests field, however, can include a single group or more than two groups.

Trade Restrictor

The trade restrictor 21 is configured to (1) determine whether the bids or offers are automated or bank originated for the purposes of selectively restricting matching between automated and bank-originated bids and offers and (2) determine whether bids or offers are latent, stale, or off market for the purposes of canceling or adjusting them to reflect expected market conditions. Referring again to FIG. 13 for example, if the message formatting standards used above are employed, the trade restricting system is configured to receive the electronic bid/order message, parse the message and check field (1) to determine if it holds 220 or 230 which indicates a single-layer or multi-layer automated price feed, as shown by block 101. If not an automated bid or offer, the trade restricting system 21 is configured to send the bid or offer message directly to the matching engine 22.

The trade restricting system 21 can also be configured to determine whether the bid/offer message has been manually submitted by one of the bank trader workstations 14 by comparing the username in field (3) of the bid/offer message to a list of known bank traders, or by use of a code indicating a bank trader (user type 20), as shown by block 102 of FIG. 13. If the trader is not a bank trader, the trade restricting system 21 is configured to discard the bid/offer message, as shown by block 103. If the trader is a bank trader, the trade restricting system 21 is configured to forward the bid/offer message to the matching engine 22 for matching with another price, as shown by block 104.

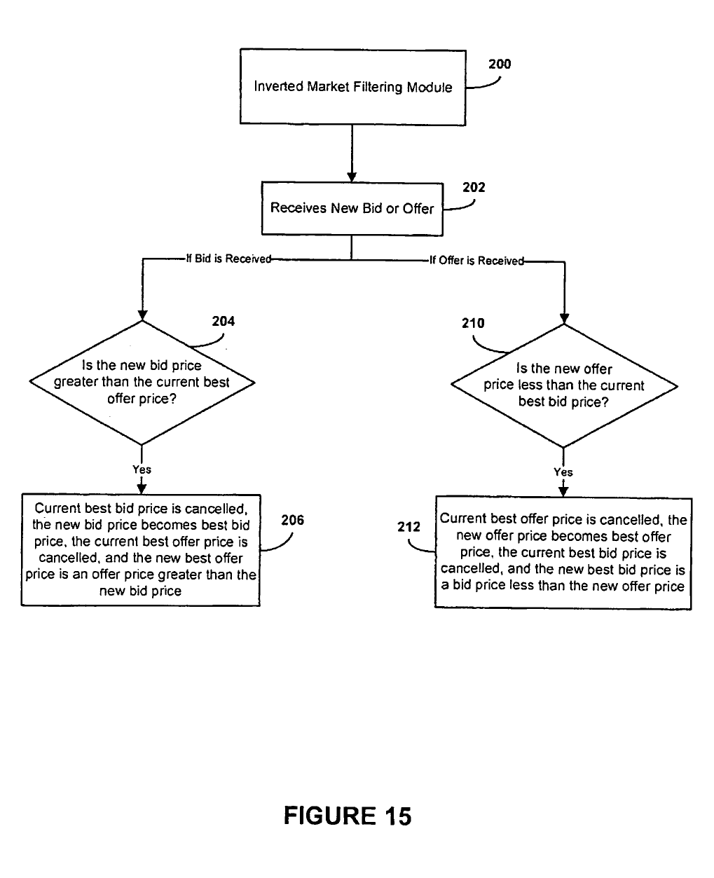

In yet another embodiment, the trade restrictor 21 is configured to determine whether bids and offers meet a range of “off market” criteria, as shown in block 115 of FIG. 13. In one embodiment, fields 7d-h, 8d-h of the single layer message of FIG. 11 and fields 5g-k for the multi-layer message of FIG. 12 indicate which criteria or filters the user has selected to restrict bids and offers. Filters that may be selected by the user include an inverted market filter, a choice market filter, an expected range filter, an intentional skew filter, and a time interval filter, which are described in more detail below in relation to FIGS. 15-19. If no filter is selected, the trade restrictor 21 forwards the bid/offer message to the matching engine 22 for matching with another price, as shown by Block 104.

If one or more filters are selected, the trade restrictor 21 screens the new bid or offer and the bids and offers in the system to determine if any of the bids and offers meet off market criteria defined by each filter, shown as Block 116. If a bid or offer does not meet off market criteria, the trade restrictor 21 forwards the bid/offer message to the matching engine 22 for matching with another price, as shown by Block 104. If a bid or offer meets off market criteria, the trade restrictor 21 can cancel the bid or offer, notify the user that the bid or offer did met off market criteria, or adjust bids and offers, as shown by Blocks 117, 118 and 119, respectively.

Matching Engine

The matching engine 22 is configured to receive the bid/offer message (block 104) and determine whether the bid or offer matches another bid or offer based on price. For instance, the matching engine is configured to execute the newly received bid or offer with previously placed orders on the opposite side of the market with a price equal to, or better than, the price of the newly received bid or offer.

If no matches are found, the matching engine 22 is configured to send the unmatched bids and offers to the GUI generator 23 for display on various trader workstations 11, 14, as shown by block 105 and FIG. 1. If a match is found, the matching engine 22 is configured to reconfirm that at least one of the bid and the offer are not automated, as shown by block 106, either by re-checking field (1) in both bid/offer message, or by sending the messages to the trade restricting system 21.

If both bid and offer are automated, then the original order is kept on display for the workstations 11, 14 (as shown by block 107) and the bid/offer message is sent back to block 105 for another attempt at matching, as shown by FIG. 13. If one of the orders is not automated, then the matching engine 22 is configured to run a credit check (as shown by block 108) on the bid and offer to see if credit limits between the banks are exceeded and to see if the credit limits associated with the workstations placing the orders have been exceeded. If the match is within all credit limits, the matching engine 22 is configured to process the match (as shown by block 109) and send the matched trade details to the respective bank settlement systems 17 and to the GUI generator 23 for possible averaging and processing by the trader using an optional averaging function, which is described in more detail below. Notably, the trade restricting system 21 can also be configured to selectively block or inhibit matching of manually placed, bank originated bids and offers with automatically generated bids and offers. Further, the trade restricting system could also be configured to selectively block or inhibit market maker to market maker transactions. The trade restricting system 21 in another aspect may restrict matching of trades below or above certain quantities for selected trader identities.

After the match has been found and approved, the matching engine 22 is configured to calculate (such as by using quantity field (d) on the bid and offer) if there is an unmatched quantity, as shown by block 110. This unmatched amount of the bid or offer is routed back to block 104 for further matching. Note this may similarly happen if either the bid or the offer have reserve quantities, as would be indicated by a smaller amount in the show field (c) of the bid/offer message. If the quantities of both the bid and offer match (an there is no reserve quantity), then the matching engine closes out the process, as shown by block 111.

It should be noted that detection of automated trade requests is not limited to above-described parsing of a bid/offer message to find some designator or flag indicating automation. The trade restricting system 21 of the present invention may be configured to detect automated and bank originated bids and offers in many ways and still be within the purview of the present invention. For instance, the trade restricting system may be able to examine the characteristics of a requested bid or offer and deduce that it is an automated bid or offer, such as by the presence of cancellation data, the delay between the bid or offer and previous similar bids or offers. Advantageously, such systems could be employed to screen bids and offers with varying formats other than those illustrated in FIGS. 11 and 12. Also notable, is that the trading restricting system could be configured to inhibit automated trades in other ways, such as by inquiring with the trading parties as to whether to match the trade, slowing matching of the trades, etc.

Graphical User Interface (GUI) Generator

Preferably, bids, offers and other transaction information are displayed by, and recorded from, the trader workstations using a collection of trading GUIs of the present invention. Preferably, these GUIs are generated by a combination of hardware and software of the workstations 11, 14 and the trading platform 13 distributed so as to maximize the speed of data transmission between the systems. However, the GUIs can be generated in a number of ways using various networks, software, hardware and other components as described above. For simplicity however, the GUI generator 23 is illustrated in FIG. 1 as residing on the trading platform 13.

An exemplary embodiment of the GUIs of the present invention, in the context of facilitating currency trading, are shown in FIGS. 2-13. For instance, the trading platform GUIs can include a trade entry screen 25, an open positions screen 26, a deal log 27 and a credit screen 28, as shown in FIG. 2.

The trade entry screen 25 includes one or more rows, each of which displays information for a particular currency pair (e.g., EUR/USD and USD/JPY). Each of the rows includes a dealing area in its center which is separated into a bid side (left) and an offer side (right). An innermost pair of boxes includes a best bid price box 29 on the left and a best offer price box 30 on the right. These price boxes display the best bid and offer available to the trader and clicking on one of the price boxes allows the trader to hit or lift the best bid or offer.

Upon clicking on the best bid or offer price boxes 29, 30, a hit/lift window 41 appears, as shown in FIG. 5, unless the single or double-click dealing mode described below is employed, in which case the hit/lift window 41 is skipped. The hit/lift window is labeled “sell” if the trader hit the bid, or is labeled “buy” if the trader lifted the offer. The hit/lift window 41 shows a price 42 and an amount 43 at which the trader will be dealing, which is the best bid or offer at the time the price box 29 or 30 was hit. A send button 44 allows the trader to submit the bid or offer to the bid and offer recording system 20. In another option, the trader workstation may be configured so that a single or double click on the best bid or offer price boxes 29, 30 immediately sends the offer without displaying the hit/lift window. In which case, a trade confirmation window 45 will be immediately displayed, as shown in FIG. 6. It should be noted that the terms “bid” and “offer” as used herein denote all types of bids and offers and therefore encompass hits and lifts.

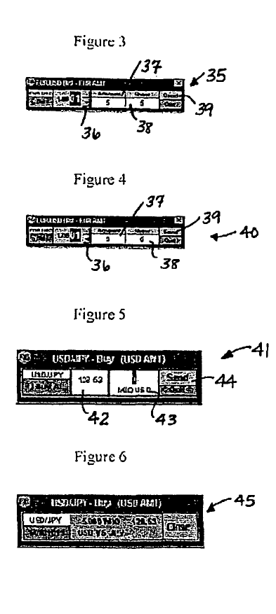

Adjacent to the price boxes on either side are a bid button 31 (left side) and an offer button 32 (right side). Selecting these buttons allows the trader to enter a new bid or offer, respectively, such as by opening a bid box 36 or an offer box 40, as shown in FIGS. 3 and 4, respectively. In the best bid box appears the current market price with the cursor over the smallest increments. Up and down arrows 36 allow adjustment of the bid price. Clicking or tabbing on a white amount box 37 allows the amount to be changed. A reserve amount can be set by selecting and changing a show box 38. Otherwise, the show box will default to the amount in the amount box 37. Clicking on a send button 39 submits the bid to the bid and offer recording system 20. The offer box 40 operates with all the same functionality of the bid box 36, except that an offer is being made.

Each of the rows of the trade entry screen 25 also contains market information areas 33 that are on either side of the buttons 31, 32. On the left, the market information area shows bid information, while the market information area on the right shows offer information. The market information includes the number of orders and total amount of all the orders at a particular price and currency pair. Orders placed by the trader workstation on which the trade entry screen 25 is being shown, are shown in yellow. Prices in the market information areas 33 that are within 10 points of the best price are shown in a white background and if more than 10 points from the best price are shown in a black background. Vertical bars 34 are scaled to the amount available at that price, with a numeric indication is inside the bars while the number of participants making up a bid or offer is indicated above the vertical bar. Optionally, the vertical bars may also be color coded to reflect the total amount. As another option, trades that have been restricted by the trade restricting system 21 may be displayed, but not accessible for hitting and lifting by bank trader workstations 14. For instance, automated price feeds from other banks may be displayed on the bank trader workstation in gray to indicate inaccessibility.

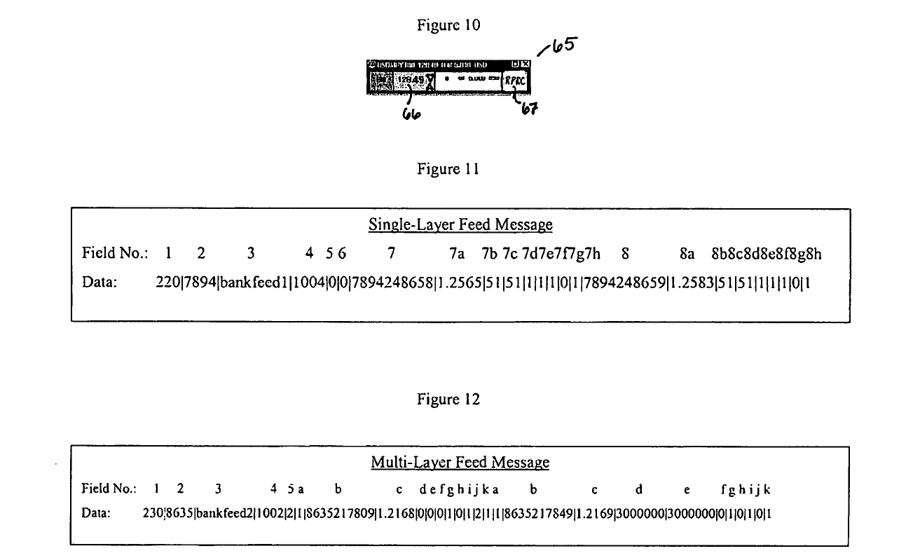

FIG. 10 illustrates a re-price balance window 65 which is displayed when the trader selects the order placed from the workstation (displayed in yellow) in the market information areas 33. The re-price balance window 65 includes up and down arrows 66 next to a display of the price of the original bid or offer and a re-price button (RPRC) 67. The up and down arrows 66 allow the price for the remaining balance of a bid or offer to be changed, and hitting the re-price button 67 submits this change to the memory 80.

In the embodiment illustrated above, the change is submitted as a message (such as the messages shown in FIGS. 11 and 12) containing the new price for the remaining quantity and cancellation instructions for the previous bid or offer. The advantage of using the re-price function is that a new bid or offer is submitted and replaces the original bid or offer for the remaining outstanding quantity of the bid or offer without having to cancel the previous bid or offer, calculate the remaining balance manually and then submit a new bid or offer. Notably, if none of the quantity of the bid or offer has been matched, then essentially the entire bid or offer has been repriced. Also, the trading platform 13 may be configured to replace the price of a pending bid or offer with the new price of the bid or offer, without a cancellation, maintaining its place in the queue for instances wherein bids and offers are matched in the order received.

Referring again to FIG. 2, the open positions screen 26 lists current obligations of the trader by currency pair and also includes a plurality of data fields aligned with each currency pair including a position field 52, an average price field 46, a market price field 47, a profit/loss field 48, a test price field 49, a test profit/loss field 50 and a counter position field 51. Displayed in the position field 52 are the current long or short obligations for that currency pair for the trader. The average price field 46 indicates the average price for all deals transacted for the currency pair for that trading day. In the market price field 47, the market price for that currency is displayed.

The profit/loss field 50 is configured to display a calculated difference in the price at which the position was established and the current market price for the position, i.e., the profit or loss on the position if it were closed at the current price. In response to entry into the test price field 49 of a hypothetical price, the test profit/loss field 50 is configured generate a theoretical profit or loss on the position based upon that price. In other words, it allows the trader to see what the affect on his position would be if the market were to move to different levels. This is similar to the profit/loss field 50 but using the hypothetical price. The counter position field 51 shows the equivalent amount of the secondary currency, long or short.

The deal log 27 also includes several data fields, each group of data fields corresponding to recent transactions for currency pairs in chronological order, as shown in FIG. 2. The fields include a buy/sell field 53, an amount field 54, a rate field 55, a secondary amount field 56, a deal number field 57, date and time fields 58, an aggregate field 59 and a value date field 60. The buy/sell field 53 indicates whether the transaction is a purchase or sale of the currency pair. The amount field 54 is the amount of the transaction in the selected base currency. The rate field 55 indicates the exchange rate at which the transaction was matched. The secondary amount field 56 describes the amount of the transaction in the secondary currency of the currency pair. A unique deal number associated with the deal is listed in the deal number field 57. The date and time fields 58 indicate the exact date and time the transaction was matched by the matching engine 22. The aggressor field 59 will contain a yes/no value which indicates whether the client was aggressive or passive on the trade. The value date field 60 contains the settlement date, which is the day upon which each party in the trade must deliver the respective amount of currency.

The credit screen 28 includes a maximum credit exposure field 62, an actual credit exposure field 63 and an available credit exposure field 64. The maximum credit exposure field 62 indicates the limit of credit extended to the trader by the trader's bank. Actual credit exposure is the credit exposure from the current positions of the trader and is displayed in the actual credit exposure field 63. The available credit exposure field 64 is configured to list the difference between fields 62 and 63, which is the amount of credit that the trader may use in future deals. Any transactions that exceed these amounts will be blocked by the matching engine 22.

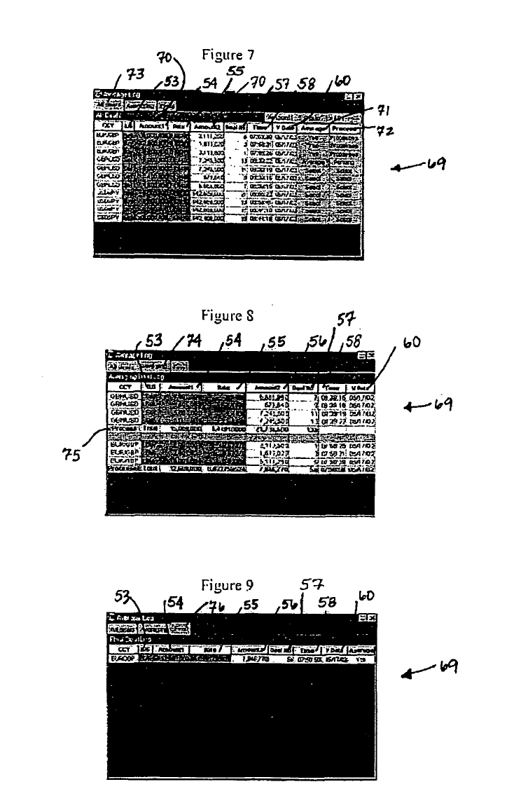

Selection of a functions pull-down menu 68 (as shown in FIG. 2) reveals an option to open an average log screen 69, as shown in FIG. 7. The average log screen includes an all deals tab 73 configured to display some of the same fields as the deal log 27, including the buy/sell field 53, the amount field 54, the rate field 55, the secondary amount field 56, the deal number field 57, the time field 58 and the value date of the deal field 60.

In addition to these fields, the average log screen 69 includes a deals awaiting action listing 70, an average indicator field 71 and a processing status field 72. The deals awaiting action listing 70 is configured to display the number of deals that have been matched by the matching engine 22 but have not yet been included in an averaging or designated as individual trades. In the average indicator field 71, deals are described as either “select,” indicating that the deal is capable of selection for averaging, “average,” indicating that the deal has been selected for averaging and “yes,” indicating that the deal was processed using the averaging function. In the processing status field 72, deals can be described as “select,” meaning the deal has not yet been processed and is selectable for averaging, “pending,” meaning that the deal has been selected for averaging and “processed,” meaning that the deal has been processed.

Selection of the “select” indicator in the average indicator field 71 changes the indicator to “average,” which prepares the deal for processing on an averaging tab 74 of the average log screen 69, as shown in FIG. 8. The averaging tab 74 of the average log screen 69 includes trades ready for processing grouped by currency pair and whether they are buy, or sell, transactions. A process selection field 75 is associated with an averaged transaction that includes a new deal number (which in the illustrated embodiment is the number of the latest deal with an appended a, e.g., “13a”) in the deal number field 57, the average rate in the rate field 55 and the total amount of all of the deals in the primary and secondary amount fields 54, 56.

Selection of the process selection field 75 then submits the deals to the settlement system 17 for processing either as a batch for the entire amount at the average price, or alternatively, for processing singly in the original deal amounts but at the new, averaged price. Notably, because the bank is the intermediary that books the trades with other banks, the trader is free to batch averaged trades for clearance regardless of whether bank or trade with which the deal has been made is the same for all deals. In addition, the alternative of processing of the trades singly, but at the averaged price simplifies clearance while still allowing the identity of the original trades to be documented and maintained. Regardless of how the trade is processed, a final tab 76 of the average log screen 69 lists the processed trades in batched, averaged form for simplicity, as shown in FIG. 9.

Exemplary System Architecture

A trading platform 13 of another embodiment of the present invention is shown in FIG. 14. The trading platform includes a processor 77 that communicates with other elements within the trading platform, or the computerized trading system 10, via a system interface or bus 78. Also included in the trading platform 13 is a display device/input device 79 for receiving and displaying data. The display device/input device may be, for example, a keypad or pointing device that is used in combination with a display screen. The trading platform 13 further includes memory 80, which preferably includes both read only memory (ROM) 81 and random access memory (RAM) 82. The ROM 81 is used to store a basic input/output system (BIOS) 83, containing the basic routines that help to transfer information between elements within the trading platform 13.

In addition, trading platform 13 includes at least one storage device 84, such as a hard disk drive, a floppy disk drive, a CD-ROM drive, or optical disk drive, for storing information on various computer-readable media, such as a hard disk, a removable magnetic disk, or a CD-ROM drive, or optical disk drive, for storing information on various computer-readable media, such as a hard disk, a removable magnetic disk, or a CD-ROM disk. As will be appreciated by one of ordinary skill in the art, each of these storage devices 84 is connected to the system bus 78 by an appropriate interface. The storage devices 84 and their associated computer-readable media provide non-volatile storage for the trading platform 13. It is important to note that the computer-readable media described above could be replaced by any other type of computer readable media known in the art. Such media include, for example, magnetic cassettes, flash memory cards, digital video disks, and Bernoulli cartridges.

A number of program modules may be stored by the various storage devices, such as within RAM 82 (as shown in FIG. 14) or within the storage device 84 (as not shown for clarity). Such program modules include an operating system 85, a bid/offer receiving module 86, an automated bid/offer detection module 87, a bank trader detection module 88, a price matching module 89, a dual side automated bid/offer detection module 90, a credit checking module 91, an unmatched quantity calculation module 92, an inverted market filtering module 200, a choice market filtering module 300, an expected range filtering module 400, an intentional skew filtering module 500, and a time interval filtering module 600. The modules control certain aspects of the operation of the trading platform 13, as is described above, with the assistance of the processor 77 and the operating system 85. While described as separate modules, these functions may, instead, be integrated.

Also located within the trading platform 13, is a system interface 93 for interfacing and communicating with other elements of the computerized trading system 10. It will be appreciated by one of ordinary skill in the art that one or more of the computerized trading system's components may be located geographically remotely from other computerized trading system components. Furthermore, one or more of the components may be combined, and additional components performing functions described herein may be included in the computerized trading system.

Filtering Modules

As illustrated in FIG. 14, one embodiment of the trading platform includes filtering modules that are executed by the trade restrictor 21 for (1) detecting stale, latent, or off market bids or offers and (2) preventing the off market bids or offers from being booked by the trading system 10. The user can select one or more filtering modules to screen the bids and offers, including an inverted market filtering module 200, a choice market filtering module 300, an expected range filtering module 400, an intentional skew filtering module 500, and a time interval filtering module 600.

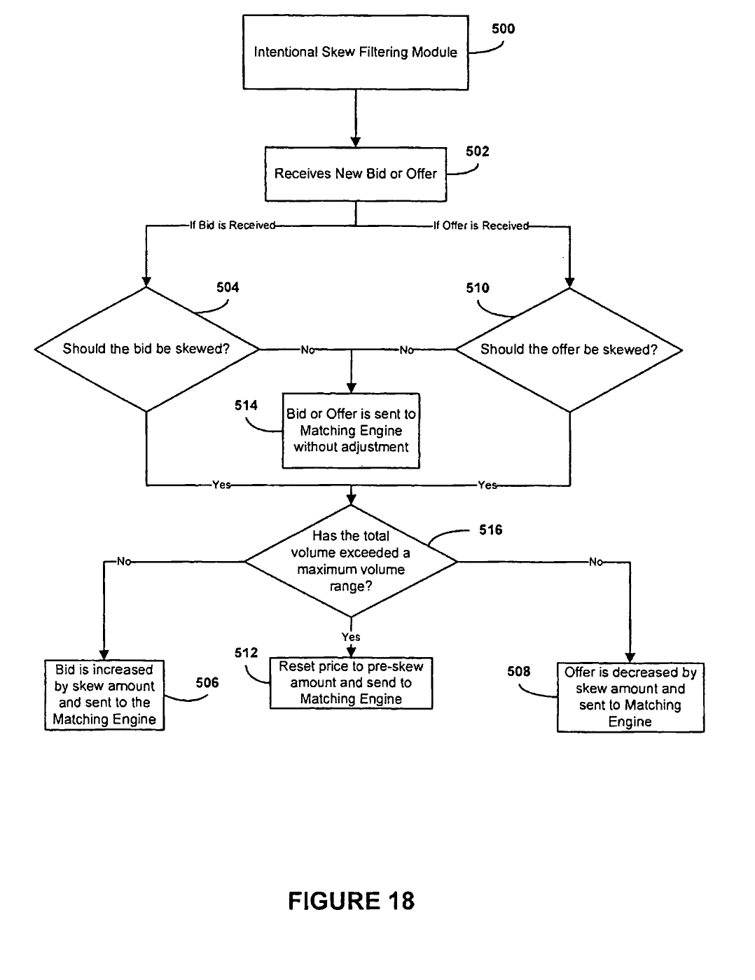

The trading system 10 may provide for the selection of off market filters through fields in the messages illustrated in FIGS. 11 and 12. For example, message fields 7d-h for single-layer feed bid messages, fields 8d-h for single-layer feed offer messages, and fields 5g-k for multi-layer feed bid/offer messages can each represent one of the filters described below in relation to FIGS. 15-19. For example, fields 7d, 8d, and 5g represent the inverted market filter, fields 7e, 8e, and 5h represent the choice market filter, fields 7f, 8f, and 5i represent the expected range filter, fields 7g, 8g, and 5j represent the intentional skew filter, and fields 7h, 8h, and 5k represent the time interval filter. For most of these fields, if the value in the field is “0,” the filter should be turned off, and if the value of the field is “1,” the filter should be turned on. For some of the filters, any amount in the field greater than zero indicates a value to be used by the filter, such as for the intentional skew filter described below in relation to FIG. 18.

Filters can also be enabled/disabled and parameters needed for those filters can be communicated to the server in other ways. For example, in another field in the price message (as shown in FIGS. 11 and 12). Through the use of another message which is sent from the client to the server in response to a bank trader's change of a parameter on his trading screen. As another example, through a static setting which is agreed ahead of time and is loaded into the server when it is initialized.

Inverted Market Filtering Module

In a typical market, the best bid price is slightly lower than the best offer price, reflecting the principal that buyers want to buy at the lowest price possible and sellers want to sell at the highest price possible. However, if the best bid price is greater than the best offer price, then the market is considered inverted because the buyer is willing to pay more than the price at which the seller is willing to sell. Therefore, the inverted market filter is configured to assume that if the new bid price is higher than the current best offer price, then the current best bid price and best offer price are latent or stale and should be updated. Similarly, if the new offer price is lower than the current best bid price, then the current best offer price and the best bid price are assumed to be latent or stale and should be updated. The table below illustrates an example how the inverted market filter affects the best offer price and best bid price in the system.

| | Best Bid Price | Best Offer Price |
|---|---|---|
| Existing Market | 50 | 52 |
| New Prices | 53 | 55 |
| Market without using Inverted | 53 | 52 |
| Market Filter | | |
| Market using the Inverted | 53 | 55 |
| Market Filter | | |

FIG. 15 illustrates the flow of an embodiment of the inverted market filtering module 200. In Block 202, the filter receives the new bid or offer. If a new bid is received, the new bid price is compared to the current best offer price in the system in Block 204. If the new bid price is greater than the current best offer price, the current best bid price is cancelled, the new bid price becomes the new best bid price (assuming that it is higher than the original best bid price), the current best offer price is cancelled, and the new best offer price is reset to the closest (in sequence or in amount) offer price that is higher than the new bid price, as shown in Block 206. In this instance, then, the new best offer price is detected to deviate from a range of prices that do not cause an inverted market, and the new best offer price is “restricted” by being replaced with an offer price that does not cause the inverted market criteria.

Notably, although the trade restrictor is described as replacing bids and offers that cause the market to be inverted with those that do not, the bids or offers may simply be cancelled or presented to the trader for modification, cancellation or approval. Therefore, the term “restricted” should be construed broadly to include modification, cancellation or seeking approval so as to avoid display, matching, and ultimately booking, of the restricted bid or offer without some intervening process.

Similarly, if a new offer is received in Block 202, the new offer price is compared to the current best bid price in the system in Block 210. If the new offer price is less than the current best bid price, the current best offer price is cancelled, the new offer price becomes the new best offer price, the current best bid price is cancelled, and the new best bid price is a bid price that is lower than the new offer price, as shown in Block 212.

Choice Market Filtering Module

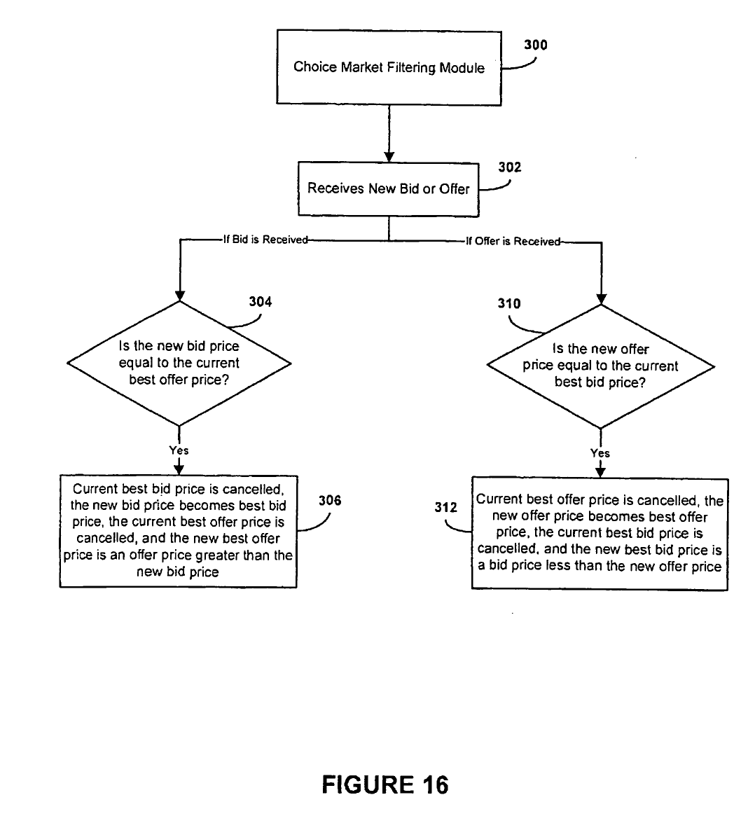

A choice market is one in which the best bid price and best offer price are equal. The choice market filtering module 300, illustrated in FIG. 16, receives a new bid or offer in Block 302. If a new bid is received, the module 300 determines if the new bid price submitted is equal to the current best offer price in the system, shown in Block 304. Like the inverted market filter module 200 described above, the choice market filtering module 300 assumes that if the new bid price is equal to the current best offer price in the system, then the current best bid price and best offer price are latent or stale and should be updated. If the new bid price is equal to the current best offer price, the system updates the best bid price with the new bid price and the best offer price with an offer price that is greater than the new bid price, as shown in Block 306.

Similarly, if a new offer is received, the module determines if the new offer price submitted is equal to the current best bid price in the system, shown in Block 310. If the new offer price is equal to the current best bid price, the system updates the best offer price with the new offer price and the best bid price with a bid price that is lower than the new offer price, as shown in Block 312.

In an alternative embodiment, if the new bid or offer prices would result in an inverted or choice market, the inverted market filter module 200 and the choice market filtering module 300 are configured to notify the submitting bank before updating the best bid and best offer prices as described above. Upon notification, the bank has the opportunity to review the new bid or offer price for errors, change the new bid or offer price, or cancel it. If the bank intended to submit the new bid or offer price or another price that meets the off market criteria for these modules, the modules are configured to update the best bid and offer prices with the approved bid or offer.

Expected Range Filtering Module

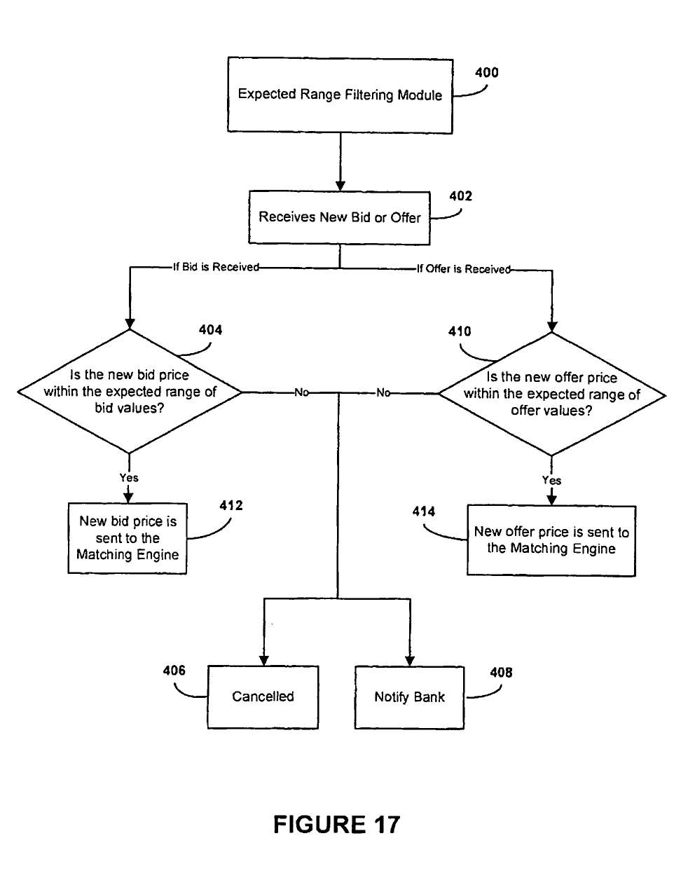

The expected range filtering module 400 detects new bid and offer prices that do not fall within a statistically defined range of values that would be expected by the market. In the embodiment illustrated in FIG. 17, the expected range filtering module 400 receives a bid or offer submitted by a bank market maker, shown in Block 402. The module 400 then compares the new bid price to an expected range of bid values, as shown in Block 404, or compares the new offer price to an expected range of offer values, as shown in Block 410. In Block 406, the bid or offer is cancelled if the bank's new bid or offer falls outside of the respective ranges. Alternatively, as shown in Block 408, the trade restrictor can notify the submitting bank that the bid or offer fell outside the expected range and allow the bank trader to modify the bid or offer or choose to submit the original bid or offer without interference from the expected range filter of the trade restrictor. If the bid or offer falls within the expected range, the bid or offer is sent to the matching engine, as shown in Blocks 412 and 414.

The expected ranges used by the expected range filtering module 400 can be defined using maximum and minimum prices or volumes at which the trade restrictor expects new bids and offers to fall. For example, the maximum and minimum prices can be defined using one or more standard deviations, Bollinger Bands or inflection points of a collection of recent or historical posted or matched bids and offers. Generally, this allows the expected ranges to be defined by current market conditions.

Alternatively, or in addition to defining the expected ranges by current market conditions, the expected ranges may be defined using the identities and past behaviors of a particular trader or group of traders (e.g., banks or market makers). For example, the expected ranges may be set at one or more standard deviations of the bid prices or offer prices submitted by a bank in past time period or similar situation, such as a during a bull market, a bear market or when interest rates are rising or falling. Additionally, the expected range criteria can be set at one or more standard deviations of the volume of trades submitted by a particular bank in past transactions. Although standard deviations are described invention is not limited to standard deviations from sets of data, and alternative methods of defining statistical ranges are within the scope of the invention.

As noted above, the expected range could be determined by a bank to be within a certain number of standard deviations (can be chosen by each bank) to the running average. The standard deviations and running average can be standard or exponentially weighted (selectable by each bank), the amount of time (and or ticks) to include in the running average and standard deviation and the weighting factor can also be chosen by the bank. Alternatively, the bank could choose to use a straight percentage difference from the running average which the trader can modify in real time.

Other more complex methods based on stochastic calculus, momentum, FFT (Fast Fourier Transforms), binomial trees, neural networks and genetic algorithms, fuzzy logic, fractals, and/or chaos theory may be employed in the future as methods to determine the valid range for a given price, or to determine parameters for use in other models to identify an incoming price that is outside of the expected range.

Intentional Skew Filtering Module

The intentional skew filtering module 500, illustrated in FIG. 18, allows the bank market maker to skew a bid or offer price to more aggressively pursue a particular financial instrument. The intentional skew filtering module 500, according to one embodiment, receives a new bid or offer in Block 502. In Blocks 504 and 510, the module 500 determines whether the bid or offer, respectively, should be skewed. If the amount should not be skewed, the module 500 sends the bid or offer to the matching engine without adjustment, as shown in Block 514.

If the bid or offer should be skewed, the module 500 detects whether previous bids or offers have been made for the same financial instrument by the same buyer, and calculates a total volume of financial instrument transacted with an intentional skew. In a block 516 the skew filtering module 500 logic is configured to determine whether the total volume has exceed a maximum volume range set by the trader, or determined statistically as described above. If the answer is no, the module 500 increases the bid by the amount indicated in the bid message or decreases the offer by the amount indicated in the offer message and sends the bid or offer to the matching engine, as shown in Blocks 506 and 508, respectively. If the answer is yes in block 516, the skew is reduced or the price is reset to its unskewed amount in a block 512.

As an example of how a skew request can be detected and generated, the module 500 is configured to parse the bid or offer message to determine whether the user wants to skew the bid or offer amount. For example, field 7j indicates the amount by which a single-layer feed bid should be skewed, field 8j indicates the amount by which a single-layer feed offer should be skewed, and field 5f indicates the amount by which a multi-layer feed bid or offer should be skewed. The number in the skew fields indicates the amount by which the price bid or offer should be skewed. For example, if the skew field is 1, 2, or 3, then the amount should be skewed by 1, 2, or 3 pips, respectively. If a bid is skewed, the amount will be increased by the amount of pips, and if an offer is skewed, the amount will be decreased by the amount of pips. If the skew field is 0, then the amount is not skewed. If the user does not want to skew the bid, the skew fields are equal to zero. In addition, if the bid or offer amount to be skewed is in a multi-layer feed bid or offer, the skew field is reset to zero after the skewed amount is booked, thereby returning the amount of the bid or offer to the pre-skew amount.

Time Interval Filtering Module

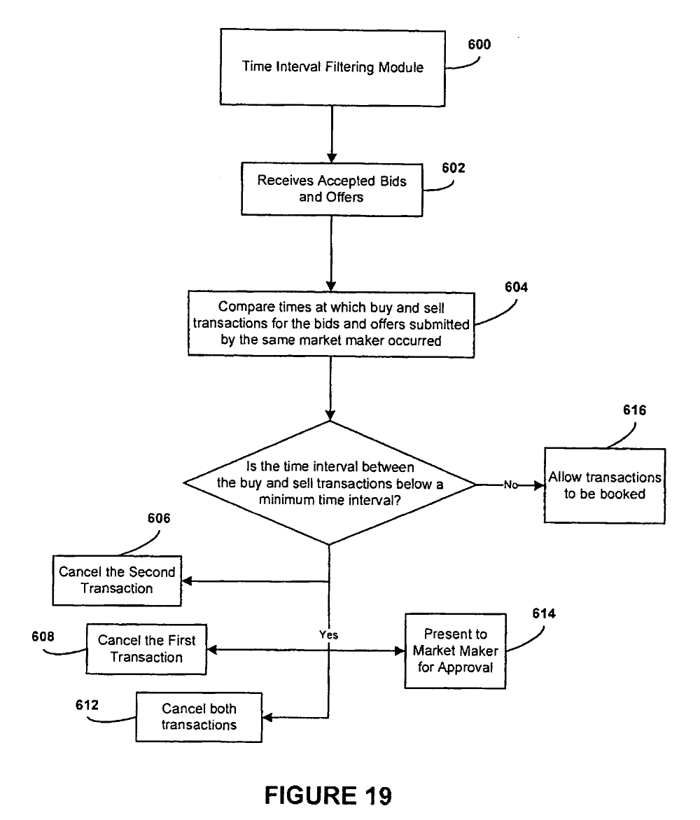

The time interval filtering module 600, illustrated in FIG. 19, prevents buy and sell transactions for bids and offers submitted by the same market maker from being accepted simultaneously or within a short time period by another trader or group of traders. In Block 602, the time interval filtering module 600 receives accepted bids and offers. Next, at Block 604, the module 600 determines which traders submitted the bids and offers and which traders accepted them and compares the times at which the buy and sell transactions for the bids and offers were submitted or were matched. If the time interval is below a minimum acceptable time interval, the second transaction is cancelled, as shown in Block 606. Alternatively, the first transaction is cancelled, shown in Block 608, or both the first and second transaction are cancelled, as shown in Block 612. In another alternative, shown in Block 614, both transactions are presented to one or both of the traders (in particular a bank or market maker trader) for manual approval before allowing the deal to be processed by the system. If the time interval does not fall within the minimum time interval, the transactions are allowed to be booked by the system, as shown in Block 616.

A further embodiment of the invention allows the trader to enable any combination of the filters described above for a particular transaction or group of transactions. For example, the trader may want to have the inverted market filter and the choice market filter selected at all times to avoid making bids that are equal to or above the best offer price. Additionally, the trader may want to be able to make skewed bids or offers but have the expected range filter apply after the skewed bid or offer is accepted. Furthermore, the trader may want to ensure that the same opposite party trader does not buy and sell the bank's offers and bids at the same time or within a minimum time interval in addition to having the protections from the expected range filter and the inverted market and choice market filters.

Various figures of the present application include block diagrams, flowcharts and control flow illustrations of methods, systems and program products according to the invention. It will be understood that each step or block of the block diagram, flowchart and control flow illustration, and combinations of blocks in the block diagram, flowchart and control flow illustration, can be implemented by computer program instructions. These computer program instructions may be loaded onto, or otherwise executable by, a computer or other programmable apparatus to produce a machine, such that the instructions which execute on the computer or other programmable apparatus create means for implementing the functions specified in the block diagram, flowchart or control flow block(s) or step(s).

These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustration support combinations of means for performing the specified functions, combinations of steps for performing the specified functions and program instruction means for performing the specified functions. For example, FIG. 1 shows the GUI generator 23 for generated the various GUIs illustrated herein, the matching engine 22 for matching bids and offers and the automated price feed generator 16 for automatically generating a feed of bids and offers. It will also be understood that each block or step of the block diagram, flowchart or control flow illustration, and combinations of blocks or steps in the block diagram, flowchart or control flow illustration, can be implemented by special purpose hardware-based computer systems which perform the specified functions or steps, or combinations of special purpose hardware and computer instructions.

The present invention includes many advantages. For example, the various off market filters that can be implemented by the trade restrictor 21 serve to control situations in which stale, incorrect, inefficient or predatory bids and offers are being submitted, thus protecting the traders, and in particular, the market making banks that provide a depth of market with automated bids and offers. For example, controlling deviations from an expected price range using the inverted market filter 200, the choice market filter 300 and the expected range filter 400 protects a trader from posting bids and offers that may subject them to large losses. Bids and offers that have excessively high or low prices as determined by different metrics are adjusted to reflect prevailing market conditions, sent to the trader for approval or simply removed or not presented for a transaction. Similarly, the use of a delay range to by the time interval filter 600 inhibits placement or matching of stale bids and offers, or closely timed bids and offers between a same pair of traders. This prevents any particular trader from alternatively buying and selling similar financial instruments from the same opposing trader, such as a market maker, and driving up transaction costs for the market maker with no net result. The present invention can also detect deviations from expected volumes, which can be used to reduce or eliminate skew amounts applied to automated bids and offers so that the trader does not inadvertently end up overweight in one or more securities.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A computerized trading system for facilitating transactions of financial instruments between a plurality of traders, said computerized trading system comprising:
a user interface configured to receive a plurality of bids and offers from the traders and store the bids and offers in a memory, each of the bids and offers having transaction information including at least a price, a quantity, and a type of financial instrument;
a matching engine configured to compare the bids and offers and to match bids with offers using at least a portion of said transaction information associated with each of the bids and offers; and
a trade restrictor configured to receive the bids and offers from said memory, detect whether the price of the transaction information associated with each of the bids and offers deviates from an expected price range, and restrict booking of each of the bids and offers having the price deviating from the expected price range.

2. A computerized trading system of claim 1, wherein the expected price range is defined by inverted market criteria, said inverted market criteria requiring bids to be equal to or lower than a best offer.

3. A computerized trading system of claim 2, wherein said inverted market criteria further requires offers to be equal to or higher than a best bid.

4. A computerized trading system of claim 3, wherein said trade restrictor is further configured to replace offers not meeting the inverted market criteria with offers meeting the inverted market criteria.

5. A computerized trading system of claim 4, wherein the offers meeting the inverted market criteria used to replace the offers not meeting the inverted market criteria are new offers.

6. A computerized trading system of claim 1, wherein the expected price range is defined by choice market criteria, said choice market criteria requiring bids to be lower than a best offer and offers to be higher than a best bid.

7. A computerized trading system of claim 6, wherein said trade restrictor is further configured to replace bids and offers not meeting the choice market criteria with new bids and offers meeting the choice market criteria.

8. A computerized trading system of claim 1, wherein the expected price range criteria is defined by requiring new bids and offers to be within a statistical range calculated using existing bids and offers.

9. A computerized trading system of claim 8, wherein the statistical range includes a standard deviation calculation of the existing bids and offers.

10. A computerized trading system of claim 1, wherein the expected price range is defined using a previous price behavior of a same one of the traders.

11. A computerized trading system of claim 11, wherein the selected one of the traders is a market maker.

12. A computerized trading system for facilitating transactions of financial instruments between a plurality of traders, said computerized trading system comprising:
a user interface configured to receive a plurality of bids and offers from the traders and store the bids and offers in a memory, each of the bids and offers having transaction information including at least a price, a quantity, and a type of financial instrument;
a matching engine configured to compare the bids and offers and to match bids with offers using at least a portion of said transaction information associated with each of the bids and offers; and
a trade restrictor configured to receive the bids and offers from said memory, calculate a delay associated with each of the bids and the offers, detect whether the delay associated with each of the bids and offers deviates from a delay range, and restrict booking of each of the bids and offers having the delay deviating from the delay range.

13. A computerized trading system of claim 12, wherein the trade restrictor is further configured to detect whether the price of the transaction information associated with each of the bids and offers deviates from an expected price range, and restrict booking of each of the bids and offers having the price deviating from the expected price range.

14. A computerized trading system of claim 12, wherein the transaction information associated with each of the bids and offers includes a timestamp, and wherein the trade restrictor is further configured to calculate the delay using the timestamp.

15. A computerized trading system of claim 12, wherein the transaction information associated with each of the bids and offers includes a trader identification and wherein the matching engine is configured to issue a match timestamp and wherein the trade restrictor is further configured to calculate the delay using the match timestamp and the trader identification.

16. A computerized trading system of claim 15, wherein the trade restrictor is further configured to calculate the delay between the match timestamp of a pair of matched bids and offers, each of the pair of matched bids and offers having at least one same trader identification.

17. A computerized trading system for facilitating transactions of financial instruments between a plurality of traders, said computerized trading system comprising:
a skew generator used to calculate the price of the bids and offers, including a skew amount included in the price;
a user interface configured to receive a plurality of bids and offers from the traders and store the bids and offers in a memory, each of the bids and offers having transaction information including at least the price, a quantity, a type of financial instrument and a trader identification;
a matching engine configured to compare the bids and offers and to match bids with offers using at least a portion of said transaction information associated with each of the bids and offers; and
a trade restrictor configured to receive the bids and offers from said memory, calculate a total volume of financial instruments in the bids or offers matched by the matching engine and having a same trader identification, detect whether the total volume exceeds a volume range, and reduce the skew amount used by the skew generator in response to the volume range being exceeded.

18. A computerized trading system of claim 17, wherein the trade restrictor is configured to reduce the skew amount to zero in response to the total volume exceeding the volume range.

19. A method for facilitating transactions of financial instruments between a plurality of traders, said method comprising:
receiving a plurality of bids and offers from the traders and storing the bids and offers in a memory, said bids and offers having transaction information including at least a price, a quantity and a type of financial instrument;
comparing the bids and offers and matching the bids and offers using at least a portion of the transaction information associated with each of the bids and offers;
receiving the bids and offers from the memory;
detecting whether the price of the transaction information associated with each of the bids and the offers deviates from an expected price range; and
restricting booking of each of the bids and offers having the price deviating from the expected price range.

20. A method of claim 19, wherein detecting whether the price of the transaction information deviates from an expected range includes detecting whether the bids and offers deviate from an inverted market criteria.

21. A method of claim 20, further comprising replacing bids and offers deviating from the inverted market criteria with new bids and offers falling within the inverted market criteria.

22. A method of claim 19, wherein detecting whether the price of the transaction information deviates from an expected range includes detecting whether the bids and offers deviate from a choice market criteria.

23. A method of claim 19, wherein detecting whether the price of the transaction information deviates from an expected price range includes detecting whether the bids and offers deviate from a statistical price range calculated using existing bids and offers.

24. A method of claim 19, wherein detecting whether the price of the transaction information deviates from an expected range includes detecting whether the bids and offers deviate from a previous price behavior of a same one of the traders making the bids and offers.

25. A method for facilitating transactions of financial instruments between a plurality of traders, said method comprising:
receiving a plurality of bids and offers from the traders and storing the bids and offers in a memory, said bids and offers having transaction information including at least a price, a quantity and a type of financial instrument;
comparing the bids and offers and matching the bids and offers using at least a portion of the transaction information associated with each of the bids and offers;
receiving the bids and offers from the memory;
calculating whether a delay associated with the bids and the offers deviates from a delay range; and
restricting booking of each of the bids and offers having the delay deviating from the delay range.

26. A method of claim 25, further comprising obtaining a timestamp associated with each of the bids and offers and wherein calculating the delay includes calculating an elapsed time between the timestamp of each of the bids and offers and a current time.

27. A method of claim 25, further comprising obtaining a trader identification associated with each of the bids and offers and obtaining a match timestamp at which matching of matched ones of each of the bids and offers occurs, wherein calculating the delay includes determining an elapsed time between the match timestamp of at least two pairs of matched bids and offers, each of the pairs of matched bids and offers having at least one same trader identification.

28. A method for facilitating transactions of financial instruments between a plurality of traders, said method comprising:
generating a price for each of a plurality of bids and offers, said price including a skew amount;
receiving a plurality of bids and offers from the traders and storing the bids and offers in a memory, said bids and offers having transaction information including at least the price, a quantity, a type of financial instrument and a trader identification;
comparing the bids and offers and matching the bids and offers using at least a portion of the transaction information associated with each of the bids and offers;
calculating a total volume of matched ones of the bids or offers having a same trader identification;
detecting whether the total volume for the same trader identification exceeds a volume range; and
reducing the skew amount used by the skew generator in response to detecting the total volume exceeding the volume range.

29. A method of claim 28, wherein reducing the skew amount includes reducing the skew amount to zero.
